(19) United States
(12) Patent Application Publication
(10) Pub. No.: US 2008/0204176 A1
(43) Pub. Date: Aug. 28, 2008

(54) Unequally tapped coil solenoid valve

(76) Inventors: Konjanat Sriraksat, Samutprakarn (TH); Khachornsak Nimsaila, Samutprakarn (TH); Prasit Wajanasuntorn, Samutprakarn (TH); Palagon Meeso, Samutprakarn (TH); Ming-Chih Tsai, Taoyuan County (TW); Wei Chen, Pudong (CN); Dengyan Zhou, Pudong (CN)

Correspondence Address: BIRCH STEWART KOLASCH & BIRCH, PO BOX 747, FALLS CHURCH, VA, 22040-0747, US

(21) Appl. No.: 12/071,761

(22) Filed: Feb. 26, 2008

Related U.S. Application Data
(60) Provisional application No. 60/903,540, filed on Feb. 27, 2007.

(51) Int. Cl. H01F 7/08

(52) U.S. Cl. 335/234

(57) ABSTRACT

This invention discloses a magnetically latching solenoid valve and a solenoid thereof. The solenoid includes a coil disposed around a bobbin and divided into two sections by a tap for adjustable pull and release forces to a plunger disposed therein. A first section of the coil, through magnetic induction, pulls the plunger toward a fixed stopper disposed at the lower end of the bobbin and coupled to a cylindrical yoke. A permanent magnet is disposed between the stopper and the yoke. On contact with the stopper, the plunger is held in place by the permanent magnet even after the current flow is removed from the first section of the coil. A second section of the coil, with a differing magnetic induction, returns the plunger. By the operating current at the common tapped junction of the coil, the electromagnetic force generated by the first section will add to the fixed force from the permanent magnet while the electromagnetic force generated by the second section will subtract from the fixed force from the permanent magnet. By using a tapped coil, a simpler and more efficient electronic drive can be used with reduced electrical switching losses.

The present application claims priority of U.S. provisional application Ser. No. 60/903,540, filed Feb. 27, 2007, the entire disclosures of which are hereby incorporated by reference therein.

### BACKGROUND OF THE INVENTION

1. Field of the Invention

This invention presents a magnetically latching solenoid valve in which a plunger is pulled in by a supply of operating current and held at its retracted position even after disconnecting the operating current and released upon the application of a retracting current.

2. Related Art

In conventional types of magnetically latching solenoids, the operating and retracting currents are applied to the same coil with a complicated electronic switching circuit configuration referred to as an H-bridge.

FIG. 1 is a cross-sectional view showing a conventional latching solenoid valve. A yoke 21 is formed by a rectangular frame. A lid 1 made of non-magnetic material at the top of the yoke 21 supports and positions a permanent magnet 19. The magnetic poles of the permanent magnet 19 are oriented radially towards a central portion 27 of the yoke 21. A stopper 17 is attached to the central portion 27. A bobbin 12 is disposed in the yoke 21 so that one end of the bobbin 12 can encompass the stopper 17 and a plunger 6 is inserted into the other end thereof, and has a diameter substantially the same as that of the stopper 17. The plunger 6 is movable along the axis of the bobbin 12. A coil 23 is wound around the outside of the bobbin 12. A spring 16 is disposed between the plunger 6 and the stopper 17 so as to bias the plunger 6 in such a direction as to be pushed out of the magnetic yoke 21. In this state, an air gap d is defined between the plunger 6 and the stopper 17.

FIG. 2 illustrates this concept of the H-bridge circuit used in the conventional latching solenoid. FIG. 2 shows a solenoid comprised of a coil with n1 turns connected to the operating supply b through switches s1, s2, s3 and s4. In operation, only a pair of cross connected switches, for instance, s1 and s4, is turned on at any time to direct the current through the solenoid coil while keeping the other pair of switches s2 and s3 off. To reverse the direction of current flow, the other pair of switches s2 and s3 are turned on while keeping switches s1 and s4 off.

Again referring to FIG. 1, during operation, an operating current of a predetermined direction is applied by means of electronic switches as illustrated in FIG. 2 to the coil 23 through the pair of terminals 24a and 24b to establish therein a magnetic filed H1 of the same direction as the direction of magnetization of the permanent magnet 19. By the magnetic energy corresponding to H1, the plunger 6 is pulled into contact with the stopper 17.

In this state, even if the operation current to the coil 23 is cut off, the plunger 6 is held on the stopper 17 by the magnetic attraction of the coupled permanent magnet 19. To disconnect the plunger 6 from the stopper 17, a retracting current is applied to the coil 23 in the direction reverse from the operation current. This retracting current sets up in the coil 23 to generate a magnetic field H2 in a direction opposite to the magnetic field H1. The magnetic field H2 can decrease or reduce to zero the attractive force of the permanent magnet 19. The combination of this reduction in holding force and the force of the compressed spring 16 pushes the plunger 6 back to the original position.

In the conventional latching solenoid valves with the single coil 23, the applied operating current and the retracting current are of the same magnitude. The electromagnetic force established in both directions of magnetic fields H1 and H2 are the same even though during the retraction of the plunger 6, and the force due to the compressed spring 16 is in the same direction as that of the return force established by the magnetic field H2. This will cause excessive force on a pilot orifice 29 and a plunger seal 3 of a valve 28, and needless demagnetizing field on the permanent magnet 19. The continuous excessive force on the plunger seal 3 will eventually deform the seal material and cause leakage of fluid due to improper closure of the valve 28. Since electronic switches work frequently, the power is wasted in using a switching scheme as illustrated in FIG. 2.

Furthermore, in conventional latching solenoid valves, the coil 23 is usually exposed to ambient environments, even those through using the yoke 21, the coil is not completely sealed. In conventional solenoids with an open frame, the coil is exposed to external elements that influence its performance extended period of service. The solenoid of the conventional solenoid valve is easily influenced by high humidity environment and therefore, there is a need to fully enclose the coil from being exposed to external magnetic fields and high humidity environment.

In conventional types of magnetically latching solenoids wherein the operating and retracting currents are applied to the same coil, the same magnetic forces are applied to the plunger. This is not optimum when the plunger is pulled against a compression force of the spring. Similarly, the retracting force does not have to be the same as the pull force on the plunger as the compressed spring reduces the release threshold of the holding force of the permanent magnet.

### SUMMARY OF INVENTION

It is the object of the present invention is to provide a latching solenoid valve with an unequally sectioned coil assembly for adjustably pulling and releasing forces to the plunger.

Another object of the present invention is to provide a latching solenoid in which driving the coil sections with the tapped point as the common terminal allows simpler and more efficient electronic control.

Another object of the present invention is to provide a latching solenoid which stably maintains its position against external magnetic forces, mechanical vibration, power fluctuations or ambient temperature changes.

Yet another object of the present invention is to provide a latching solenoid which is modular and can be coupled to a valve body of the diaphragm type to control larger volumes of fluid with higher flow rate.

Yet another object of the present invention to provide a latching solenoid which can be constructed within a fully sealed environment.

In a latching solenoid according to the present invention, an unequally tapped two section operating coil is provided coaxially to form a coil assembly and a plunger with high electrical resistivity is disposed inside the coil assembly in a manner to be movable along the coil axis. A first end of the plunger projects outwardly of the coil assembly and a stopper is disposed adjacent to a second end of the plunger. The stopper is coupled with one sealed end of a cylindrical yoke. The other end of the cylindrical yoke has a lid and is adjacent to the peripheral surface of the projecting portion of the plunger. The plunger and the stopper are disposed in a bobbin. A permanent magnet is disposed between the stopper and the cylindrical yoke and held in position coaxial to the coil assembly by a soft magnetic cup disposed in a plunger guide of the bobbin on which the coil assembly is wound. The stopper now acts as a pole piece for the permanent magnet. The mating end face of the plunger has a protrusion having a circular truncated conical cross section, and the corresponding face of the stopper has a recess having a cross section of complimentary truncated cone for receiving the protrusion of the plunger.

By applying an operating current to the first section of the coil to set up a magnetic field in the plunger and the pole piece, i.e. the stopper, and by the electromagnetic energy of the field, the plunger is attracted to the fixed stopper against the force of a compressed spring disposed between the plunger and the stopper. Once physical contact is established between the plunger and the stopper, the magnetic force is larger than the spring force of the compressed spring so that the plunger is held in that position. Accordingly, even if the operating current is cut off, the plunger is retained on the stopper by the attractive force of the permanent magnet.

By applying a retracting current to the second section of the coil to establish in the stopper a return magnetic field in a direction opposite to the direction of magnetization of the permanent magnet, the attractive force of the magnetic force is substantially reduced. At this time the plunger is returned to the original position by the compressed spring positioned between the stopper and the plunger by overcoming the reduced attractive force.

By providing raised ridges on the inner surface of the tubular section of the bobbin wherein the plunger is forced to move, the surface frictional force on the plunger is minimized. The radial space between the plunger and the plunger guide allows fluid to expel to the opposite section away from that to which the plunger is moving.

By providing a central cavity in the plunger open tangentially to the radial cavity at the top end allows the motion of the plunger cushioned and reduces radial chatter of the plunger.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given herein below and the accompanying drawings which are given by way of illustration only, and thus are not limitative of the present invention, and wherein:

FIG. 1 is a cross-sectional view showing a conventional latching solenoid valve;

FIG. 2 is the schematic of an H-bridge circuit showing the electrical connection of an operating coil in the conventional solenoid;

FIG. 3 is a cross sectional view showing the construction of an embodiment of the magnetically latching solenoid according to the present invention;

FIG. 4 is a circuit diagram showing the electrical connection of an operating coil section and the return coil section in the embodiment of the present invention illustrated in FIG. 3;

FIG. 5 is a circuit diagram showing a modified type of the circuit diagram of FIG. 4;

FIG. 6 is a circuit diagram showing a modified type of the circuit diagram of FIG. 4; and

FIG. 7 is a circuit diagram showing a modified type of the circuit diagram of FIG. 4.

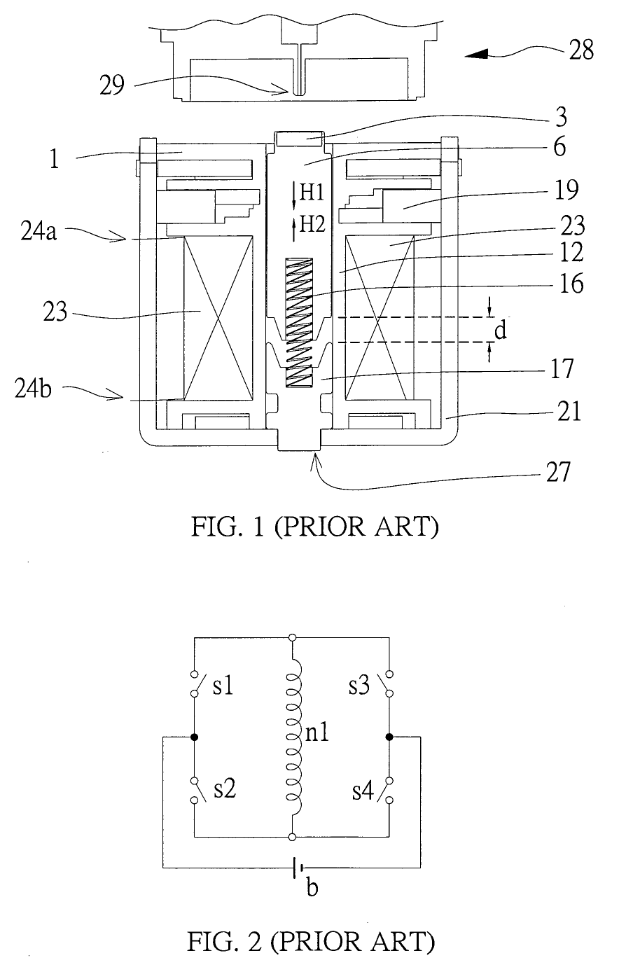

### DETAILED DESCRIPTION OF THE INVENTION

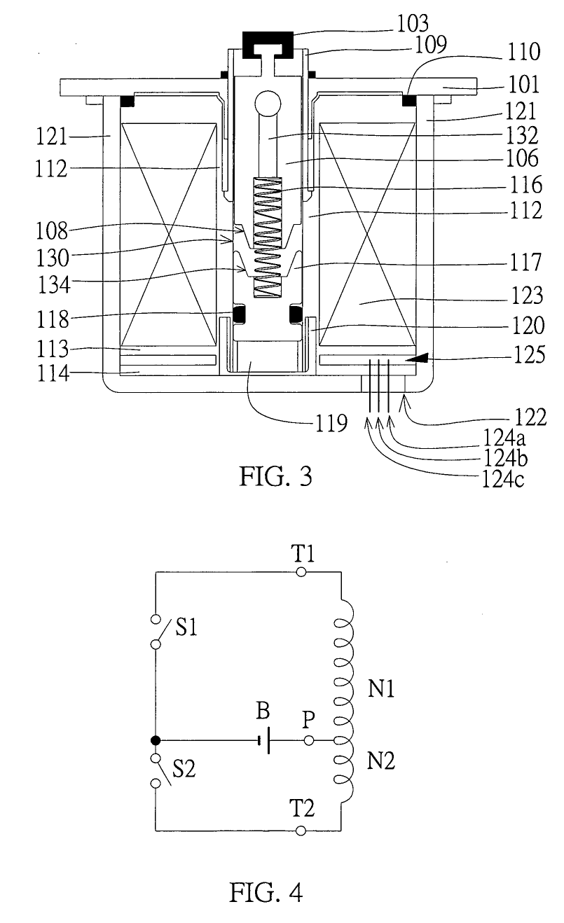

FIG. 3 illustrates the construction of an embodiment of the magnetically latching solenoid of the present invention. Referring to FIG. 3, a magnetic cylindrical yoke 121 is formed by a frame with one seal end. A lid 101 made of non-magnetic material is disposed at the top of the cylindrical yoke 121. A stopper 117 is encompassed in a bobbin 112 which is disposed in the cylindrical yoke 121. The bobbin 112 is made of non-magnetic material and has a tubular section as a plunger guide 130. One end of the bobbin 121 encompasses the stopper 117, and a plunger 106 is inserted into the other end thereof a plunger 106 and has a diameter substantially the same as that of the stopper 117. The plunger 106 is movable along the axis of the bobbin 112. A coil 123 is wound around the outside of the bobbin 112. A spring 116 is disposed between the plunger 106 and the stopper 117 so as to bias the plunger 106 in such a direction as to be pushed out of the magnetic yoke 121.

Furthermore, the fixed stopper 117 and a permanent magnet 119 disposed in the plunger guide 130 are secured in the magnetic yoke 121 in the following manner. First, the magnet 119 with a diameter substantially the same as that of the stopper 117 is disposed in a cylindrical magnetic cup 120 with a diameter slightly larger than that of the plunger guide 130 so that the cylindrical magnetic cup 120 is inserted into a coaxial cavity 115 at the bottom of the bobbin 112. The base of the cup is in flush with the base of the bobbin 112. Prior to this, an elastomeric O-ring 118 is disposed around the stopper 117 and the stopper 117 is inserted into the plunger guide 130. The O-ring 118 disposed between the stopper 117 and the plunger guide 130 will prevent any fluid present inside the plunger guide 130 from leaking out. The stopper 117 is prevented from slipping on the inner surface of the plunger guide 130 by the O-ring 118. When the stopper 117, the magnet 119 and the cylindrical magnetic cup 120 are installed properly and are all in physical contact with each other with no air gap between any of their contact surfaces. After the coil 123 is wound around the plunger guide 130 to be inserted into the cylindrical yoke 121, the top lid 101 is secured to the cylindrical yoke 121 with applicable pressure on a top seal 110 so that the aforementioned elements can be tightly magnetic coupling therebetween.

A protrusion 108 is formed on the end face of the plunger 106 on the side adjacent to the stopper 117. The protrusion 108 has a conical cross-section profile. A conical recess 134 is formed on the face of the stopper 117 corresponding to the plunger 106 for receiving the conical protrusion 108. With such an arrangement, as the contact area of the plunger 106 with the stopper 117 increases, the attractive force of the plunger 106 can be increased.

As shown in FIG. 3, the plunger 106 includes a central cavity 132 disposed therein so that the plunger 106 has a reduced weight with the same cross-section. The plunger 106 with the lighter weight can reduce the influence of the solenoid orientation on the resultant electromagnetic forces.

As shown in FIG. 3, the plunger guide 130 further includes a raised edge 109 protruding out of the lid 101 and the plunger 106 includes a seal 103 which can protrudes out of the raised edge 109. Therefore, the solenoid according to the present invention can be a modular element coupling to an external diaphragm valve (not shown).

Referring to FIGS. 3 and 4, the coil 123 is wound in the following manner. First, a lead in terminal wire 124a is soldered to the start of the enameled copper wire (not shown) and the soldered junction P is constrained to a space 125 between a first flange 113 and a second flange 114 of the bobbin 112. The magnet wire is then wound one layer at a time on the outer surface of the plunger guide 130 until N1 turns are completed. The N1 turns are the first section of the coil as an operating coil. The wire is brought out into the space 125 and the second terminal wire 124b is soldered to the magnet wire at a tapped point p. The wire is then taken inside the bobbin 112 and the winding is continued in the same direction until N2 turns are wound over the first section. This completes the second section and the magnet wire is brought out again to the space 125 and the third terminal wire 124c is soldered. The N2 turns are the second section of the coil as the retracting coil. The operating coil and the retracting coil are disposed continuously and coaxially. All these three terminal wires 124a, 124b and 124c are brought out of the cylindrical yoke 121 through a hole 122 disposed at the seal end of the cylindrical yoke 121.

The operation current for pulling and releasing the plunger 106 is illustrated in FIG. 4. Compared with the conventional solenoid, the latching solenoid according to the present invention uses only half the number of switches. Only one switch is activated for each of the operations and by holding the tapped terminal through the solder junction P, the magnetic field established in the coil 123 is directed in opposite direction depending on which of the two switches S1 or S2 is turned on. While in use, the operating coil N1 and the retracting coil N2 are connected to a power source B, as shown in FIG. 4. The two sections N1 and N2 are interconnected at one end and connected to one terminal of the power source B, and the other ends are connected to the other terminal of the power source B via switches S1 and S2, respectively. The directions of winding of the coils N1 and N2 are selected so that magnetic fields which are induced by turning on the switches S1 and S2 can be reverse in direction from each other. The magnetizing ampere-turns of turns N1 are not the same as that of turns N2. As shown in FIG. 3, the number of turns N1 is not the same as that of N2 so that the magnetic fields formed thereof are different.

For example, the retracting current through N2 turns to generate a return magnetic field is smaller than the operating current through N1 turns to generate the magnetic field which pulls the plunger so that number of N2 is smaller than that of N1. The number of turns N1 and N2 can be modified as desired.

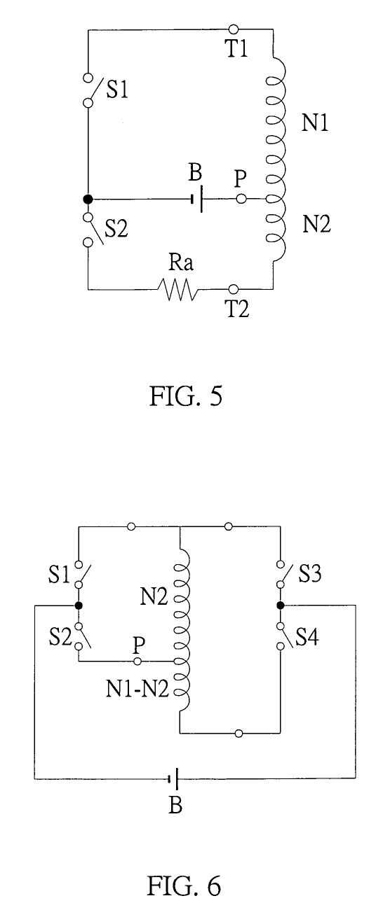

As shown in FIG. 5, the circuit diagram further includes a resistor Ra connected to the return coil N2 in series to reduce the current through N2 on the releasing period. The current on the opposite direction will demagnetize the field on the permanent magnet. Thus, the attractive force to the plunger is reduced to zero. The excessive force on a pilot orifice outside the latching solenoid and the seal 103 is avoided. The plunger 106 can return to the original position only under the force of the compressed spring 116.

As shown in FIG. 6, a coil 123 with N1 turn is acted as the operating coil by turning on a first pair of the switches S1 and S4. Partial winding of coil 123 with N2 turns is acted as the return coil by turning on a second pair of the switches S2 and S3. That is, the turns between the first pair of the switches S1 and S4 are not the same as those between the second pair of the switches S2 and S3. Compared to the conventional solenoid, although the number of switches is not reduced, the operating current and the retracting current can be designed not the same magnitude.

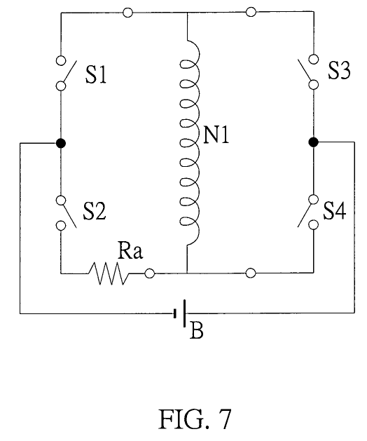

In compared with FIG. 2, to make the operating current not the same as the retracting current, a resistor Ra is added in the loop of the return circuit so that the magnetizing field generated by the return circuit is less than that generated by the operating current, as shown in FIG. 7. That is, the resistor Ra is disposed on the pathway of turning on the switches S2 and S3 but not disposed on the pathway of turning on the switches S1 and S4.

The solenoid according to the present invention can utilize the circuit, such as shown in FIGS. 4, 5, 6 or 7, which can generate different magnetizing ampere-turns during the operating and retracting, to move the plunger 106.

To sum up, while the invention has been described by way of example and in terms of preferred embodiments, it is to be understood that the invention is not limited to the disclosed embodiments. To the contrary, it is intended to cover various modifications and similar arrangements as would be apparent to those skilled in the Art. Therefore, the scope of the appended claims should be accorded the broadest interpretation so as to encompass all such modifications and similar arrangements.

What we claimed is:

1. A solenoid comprising:
a yoke with a sealed end;
a bobbin having a tubular section and disposed in the yoke;
a coil wound around the bobbin and having a first terminal and a second terminal;
a stopper disposed in the tubular section;
a permanent magnet disposed between the stopper and the yoke;
a plunger disposed in the tubular section; and
a common terminal electrically connected to the coil by a junction;
wherein a magnetizing field generated between the first terminal and the common terminal are not the same as that generated between the common terminal and the second terminal.

2. The solenoid as claimed in claim 1, wherein a protrusion is formed on the end face of the plunger on a side adjacent to the stopper.

3. The solenoid as claimed in claim 2, wherein a recess is formed on the face of the stopper corresponding to the plunger for receiving the protrusion.

4. The solenoid as claimed in claim 3, wherein the protrusion has a conical cross-section profile.

5. The solenoid as claimed in claim 1, further comprising a magnetic cup for disposing the stopper therein, having a diameter larger than that of the stopper so that the magnetic cup is inserted into a coaxial cavity of the bobbin.

6. The solenoid as claimed in claim 1, further comprising an elastomer disposed between the stopper and the tubular section to prevent any fluid present inside the cylindrical guide from leaking out.

7. The solenoid as claimed in claim 6, wherein the elastomer is an O-ring.

8. The solenoid as claimed in claim 1, further comprising a lid disposed at the top of the yoke.

9. The solenoid as claimed in claim 8, wherein the lid is secured to the yoke by a top seal.

10. The solenoid as claimed in claim 8, wherein the lid is made of non-magnetic material.

11. The solenoid as claimed in claim 1, wherein the plunger comprises a seal protruding out of a raised edge of the tubular section.

12. The solenoid as claimed in claim 1, wherein the seal end of the yoke comprises a hole enabling the first terminal, the second terminal and the common terminal brought out.

13. The solenoid as claimed in claim 1, wherein the yoke comprises two flanges and a space formed between the two flanges so that the junction is disposed in the space.

14. The solenoid as claimed in claim 13, wherein the junction is a solder.

15. The solenoid as claimed in claim 1, wherein the number of turns between the first terminal and the common terminal is not the same as that between the common terminal and the second terminal.

16. The solenoid as claimed in claim 1, further comprising a resistor disposed between the first terminal and the common terminal.

17. The solenoid as claimed in claim 1, wherein the plunger comprises a central cavity.

18. The solenoid as claimed in claim 1, wherein the stopper is disposed near the seal end of the yoke.

19. The solenoid as claimed in claim 1 being applied to a valve.

20. The solenoid as claimed in claim 1, wherein ampere-turns between the first terminal and the common terminal are not the same as those between the common terminal and the second terminal.

21. A solenoid comprising:
a yoke with a sealed end;
a bobbin having a tubular section and disposed in the yoke;
a coil wound around the bobbin to form a H-bridge circuit having a first pair of switches and a second pair of switches;
a stopper disposed in the tubular section;
a permanent magnet disposed between the stopper and the yoke; and
a plunger disposed in the tubular section;
wherein turns between the first pair of the switches are not the same as those between the second pair of the switches.

22. A solenoid comprising:
a yoke with a sealed end;
a bobbin having a tubular section and disposed in the yoke;
a coil wound around the bobbin to form a H-bridge circuit having a first pair of switches and a second pair of switches;
a stopper disposed in the tubular section;
a permanent magnet disposed between the stopper and the yoke; and
a plunger disposed in the tubular section;
wherein a resistor is disposed on the pathway of turning on the first pair of the switches but not disposed on the pathway of turning on the second pair of the switches.
